(19) United States
(12) Patent Application Publication
(10) Pub. No.: US 2008/0040767 A1
(43) Pub. Date: Feb. 14, 2008

(54) System and method of providing a set-top box application

(75) Inventors: Mary McCarthy, San Antonio, TX (US); Roland Noll, San Antonio, TX (US); Anthony J. Truppa, San Antonio, TX (US); John McClenny, San Antonio, TX (US); Scott Pettit, San Antonio, TX (US)

Correspondence Address: TOLER LAW GROUP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/502,750

(22) Filed: Aug. 11, 2006

(51) Int. Cl. H04N 7/16; H04N 7/173

(52) U.S. Cl. 725/132; 725/140; 725/152

(57) ABSTRACT

The present disclosure is directed to a system and method of providing a set-top box application. In a particular embodiment, the method includes receiving a request from a set-top box device to launch a set-top box application. The method also includes determining whether a processing system of the set-top box device supports execution of the set-top box application. The method also includes sending the set-top box application to the set-top box device after determining that the processing system of the set-top box device can support execution of the set-top box application.

### FIELD OF THE DISCLOSURE

The present disclosure relates generally to providing a set-top box application.

### BACKGROUND

Television viewing is part of daily life for many people. The wealth of content available from television service providers allows many people to find entertaining and informative programming despite their varying interests. Computing devices that are coupled to or integrated with television devices can augment television viewing by providing additional functions. For example, set-top box devices can run applications to provide program guides, games, and other content. Nonetheless, variations in the age or manufacture of set-top box devices can lead to disparities with respect to system attributes, such as processing capability. Some set-top box devices at a single customer premise, for instance, may be able to support certain applications, while others may not. Current systems typically do not determine whether set-top box devices support applications on a machine-by-machine basis. Hence, there is a need for an improved system and method of providing a set-top box application.

### BRIEF DESCRIPTION OF THE DRAWINGS

FIG. 1 is a block diagram of a particular illustrative embodiment of a system to provide a set-top box application;

FIG. 2 is a block diagram of a second particular illustrative embodiment of a system to provide a set-top box application;

FIG. 3 is a flow diagram of a particular illustrative embodiment of a method of providing a set-top box application;

FIG. 4 is a flow diagram of a second particular illustrative embodiment of a method of providing a set-top box application;

FIG. 5 is a flow diagram of a particular illustrative embodiment of a method of receiving a set-top box application;

FIG. 6 is a flow diagram of a second particular illustrative embodiment of a method of receiving a set-top box application;

FIG. 7 is a diagram of a particular illustrative embodiment of a graphical user interface to provide a set-top box application; and

FIG. 8 is a diagram of an illustrative embodiment of a general computer system.

### DETAILED DESCRIPTION OF THE DRAWINGS

In a particular embodiment, the present disclosure is directed to a system that includes an application server having a processor and a memory device accessible to the processor. The memory device includes instructions to communicate with a set-top box device to receive a request to launch a set-top box application. Further, the memory device includes instructions to determine whether a processing system of the set-top box device supports execution of the application.

In another embodiment, the present disclosure is directed to a set-top box device that includes a processor and a memory device accessible to the processor. The memory device includes instructions to send a request for an application to an application server that includes logic to determine whether a processing system of the set-top box device supports execution of the application. Further, the memory device includes instructions to communicate with the application server to receive the application after the application server determines that the processing system of set-top box device supports execution of the application.

In another embodiment, the disclosure is directed to a method of providing a set-top box application that includes receiving a request from a set-top box device to launch a set-top box application. The method also includes determining whether a processing system of the set-top box device supports execution of the set-top box application. The method also includes sending the set-top box application to the set-top box device after determining that the processing system of the set-top box device can support execution of the set-top box application.

In another embodiment, the disclosure is directed to a method of providing a set-top box application that includes sending a request for an application to an application server, where the application server determines whether a processing system of the set-top box device supports execution of the application. The method also includes receiving the application when the processing system of set-top box device supports execution of the application.

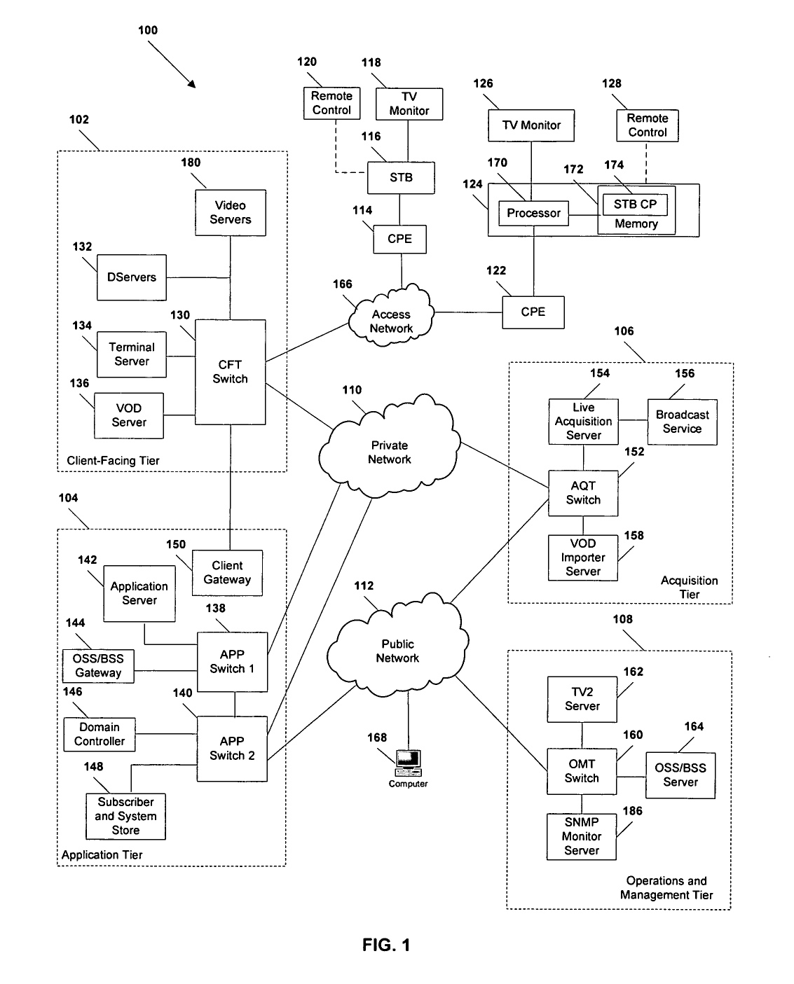

Referring to FIG. 1, an illustrative embodiment of an Internet Protocol Television (IPTV) system that may be used to provide a set-top box application is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 via the first CPE 114 and with a second representative set-top box device 124 via the second CPE 122. In a particular embodiment, the first representative set-top box device 116 and the first CPE 114 can be located at a first customer premise, and the second representative set-top box device 124 and the second CPE 122 can be located at a second customer premise. In another particular embodiment, the first representative set-top box device 116 and the second representative set-top box device 124 can be located at a single customer premise, both coupled to one of the CPE 114, 122. The CPE 114, 122 can include routers, local area network devices, modems, such as digital subscriber line (DSL) modems, any other suitable devices for facilitating communication between a set-top box device and the access network 166, or any combination thereof.

In an exemplary embodiment, the client-facing tier 102 can be coupled to the CPE 114, 122 via fiber optic cables. In another exemplary embodiment, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In a particular embodiment, the CFT switch 130 can be coupled to a video-on-demand (VOD) server 136 that stores or provides VOD content imported by the IPTV system 100. Further, the CFT switch 130 is coupled to one or more video servers 180 that receive video content and transmit the content to the set-top boxes 116, 124 via the access network 166.

In an illustrative embodiment, the client-facing tier 102 can communicate with a large number of set-top boxes, such as the representative set-top boxes 116, 124 over a wide geographic area, such as a metropolitan area, a viewing area, a statewide area, a regional area, a nationwide area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that communicates with multiple set-top box devices via a multicast-enabled network.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as interactive program guides, video gaming, display, messaging, processing of VOD material and other IPTV content, etc. In an illustrative embodiment, the application server 142 can provide location information to the set-top box devices 116, 124. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses, stock-keeping unit (SKU) numbers, other identifiers, or any combination thereof, of corresponding set-top box devices 116, 124. In another illustrative embodiment, the subscriber and system store can store data associated with capabilities of set-top box devices associated with particular customers.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer 168 coupled to the public network 112.

In a particular illustrative embodiment, one of the set-top box devices, such as the second representative set-top box device 124, can receive a request from a user to launch a particular application at the set-top box device 124. For example, the user can attempt to launch an electronic program guide (EPG), an enhanced advertising feature, a gaming application, an Internet search engine, a retail purchasing application, a music application, a VOD application, such as a VOD storefront application, or any combination thereof. The set-top box device 124 sends a request for the application to the application server 142 of the IPTV system 100.

In an illustrative embodiment, the application server 142 can validate the set-top box device 124. For example, the subscriber and system store 148 can store user account records that associate user information, location information, or any combination thereof, with identifiers of set-top boxes, such as stock keeping unit (SKU) identifiers, serial numbers, IP addresses, other identifiers, or any combination thereof. The application server 142 can receive an identifier from the set-top box device 124 with a request for an application and can retrieve data associated with the identifier from the subscriber and system store 148. The application server 142 can determine, for instance, whether the set-top box device 124 is at a location or IP address specified by data stored at the subscriber and system store 148. In another embodiment, the application server 142 can determine whether a user associated with the set-top box device 124 is permitted to access the requested application.

In a particular embodiment, after the set-top box device 124 has been validated, the application server 142 determines whether a processing system of the set-top box device 124 can support the requested application. For instance, the application server 142 can determine whether a speed of the set-top box processor 170 meets or exceeds a minimum processor speed or a recommended processor speed to execute the requested application. In another example, the application server 142 can determine whether the set-top box device 124 stores a minimum or recommended version of a client application, an operating system, or any combination thereof.

In an illustrative embodiment, the application server 142 can include a database that stores identifiers of set-top box devices in association with capabilities of those set-top box devices, such as processor speeds, versions of client applications, operating system versions, available read-only memory, available random access memory, graphics capabilities, sound capabilities, other processing capability indicators, or any combination thereof. In another embodiment, the application server 142 can be coupled to such a database or to a computing device that includes the database. The application server 142 can retrieve data related to one or more capabilities of the set-top box device 124 that has requested an application, for example, based on an identifier received with the request. The application server 142 can compare the one or more capabilities of the set-top box device 124 with one or more minimum system requirements of the application, one or more recommended system requirements of the application, or any combination thereof, in order to determine whether the set-top box device 124 can support execution of the requested application.

In another particular embodiment, the application server 142 can determine whether the set-top box device 124 can support execution of the requested application by sending header information associated with the application to the set-top box device 124. The header information can include one or more minimum system requirements, one or more recommended system requirements, or any combination thereof, to execute the application. The set-top box device 124 can compare the one or more minimum system requirements, one or more recommended system requirements, or any combination thereof, with system capabilities stored at the set-top box device 124, in order to determine whether the set-top box device 124 can support execution of the requested application. The set-top box device 124 can send data to the application server 142 indicating whether set-top box device 124 can support execution of the requested application.

If the application server 142 determines that the set-top box device 124 can support execution of the requested application, the application server 142 can send the requested application to the set-top box device 124. The set-top box device 124 can launch the application and send related content, graphics and user interfaces to the television monitor 126 coupled to the set-top box device 124.

In an illustrative embodiment, if the application server 142 determines that the set-top box device 124 cannot support execution of the requested application, the application server 142 can send to the set-top box device 124 data related to a message indicating that the application is not supported by or not available to the set-top box device 124. In another illustrative embodiment, the set-top box device 124 can generate such a message, for example, where the set-top box device 124 determines whether it can support execution of the requested application based on header information received from the application server 142.

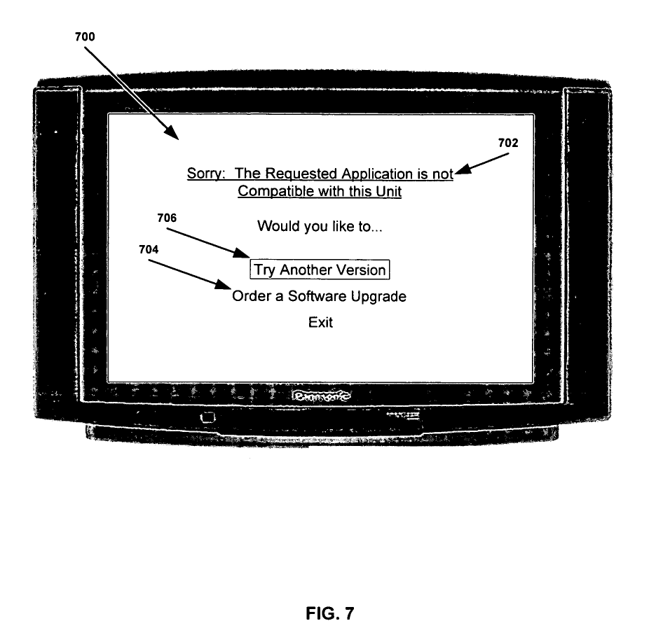

In a particular embodiment, the application server 142 can determine whether an alternate version of a requested application is available when it determines that the set-top box device 124 cannot support execution of the requested application. For example, the application server 142 can determine whether a version that requires a lower processor speed or an early client software version, is stored at the application server 142 or can be retrieved by the application server 142 via the public network 112. In an illustrative embodiment, the application server 142 can make such a determination automatically after it determines that the set-top box device 124 cannot support the requested application. Alternatively, a request can be received from the set-top box device 124 to determine whether an alternate version of the application is available. For example, a graphical user interface (GUI) can be displayed at the television monitor 126 that presents a user with a selectable option to determine whether an alternate version of the application is available. An example of such a GUI is illustrated in FIG. 7. If the application server 142 determines that an alternate version of the application is available, it can determine whether the set-top box device 124 can support the alternate version of the application. If the set-top box device 124 can support the alternate version, the application server 142 can send the alternate version of the application to the set-top box device 124.

In another particular embodiment, the application server 142 can determine whether an updated version of an operating system, client software, or any combination thereof, is available when it determines that the set-top box device 124 cannot support execution of the requested application. For example, the application server 142 can determine that execution of a requested application cannot be supported by the set-top box device 124, because the application requires a newer version of the operating system, client software, or any combination thereof, stored at the set-top box device 124. The application server 142 can determine whether newer or updated versions of the operating system, client software, or any combination thereof, is stored at the application server 142 or is available via the public network 112. If one or more newer or updated versions of the operating system, client software, or any combination thereof, are stored at the application server 142 or are available via the public network 112, the application server 142 can send a newer or updated version of the operating system, client software, or any combination thereof, to the set-top box device 124. Further, if the set-top box device 124 can support execution of the requested application as a result of an update to its operating system, client software, or any combination thereof, the application server 142 can send the requested application to the set-top box device 124. If no updated versions of the operating system, client software, or any combination thereof, are available, the application server 142 can determine that a replacement of set-top box hardware is required, such as a newer set-top box device.

In an illustrative embodiment, a graphical user interface (GUI), such as a purchase or order screen, can be displayed at the television monitor 126 that presents a user with an option to purchase updates for the operating system, client software, set-top box hardware, or any combination thereof. The GUI can be generated by the application server 142, by the set-top box device 124, or any combination thereof. In another illustrative embodiment, the application server 142 can instruct a video server 180, D-server 132, or other server of the IPTV system 100 to send video content of a channel that enables a user to place an order, make a payment, or any combination thereof, with respect to updating client software, an operating system, hardware, or any combination thereof, at the set-top box device 124. The application server 142 can send newer or updated versions of the operating system, client software, or any combination thereof, to the set-top box device 124, or schedule delivery or pick-up of a replacement set-top box device, after an order, payment, or any combination thereof, for the newer or updated versions is confirmed by the application server 142, the subscriber and system store 148, the OSS/BSS server 164, or any combination thereof.

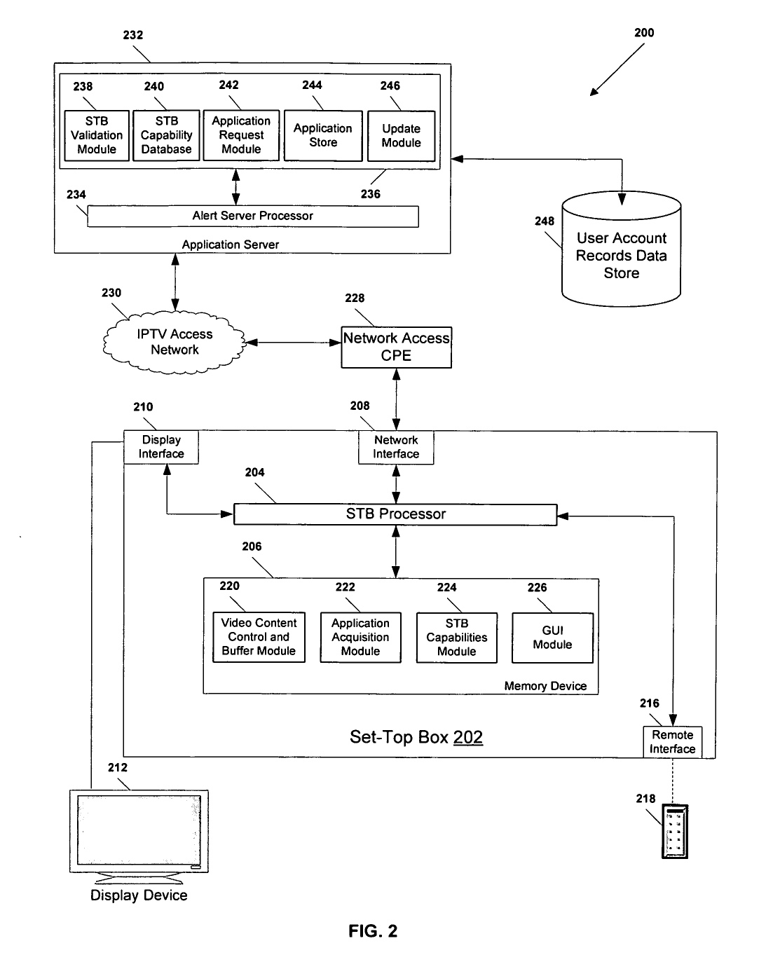

Referring to FIG. 2, a second particular embodiment of a system to provide a set-top box application is illustrated and designated generally at 200. The system 200 includes a set-top box device 202 that communicates with an application server 232 of an Internet Protocol Television (IPTV) system via an IPTV access network 230. In an illustrative embodiment, the application server 232 communicates with a user account records database 248.

As indicated in FIG. 2, the set-top box device 202 includes a STB processor 204 and a memory device 206 accessible to the STB processor 204. In an illustrative, non-limiting embodiment, the STB processor 204 can communicate with the IPTV access network 230, via the network interface 208. In a particular embodiment, network access customer premises equipment (CPE) 228 can facilitate communication between the network interface 208 and the IPTV access network 230. The network access CPE 228 can include a router, a local area network device, a modem, such as a digital subscriber line (DSL) modem, any other suitable device for facilitating communication between the network interface 208 of the set-top box device 202 and the IPTV access network 230, or any combination thereof. Further, the STB processor 204 can communicate video content, graphical user interfaces, and other content to a display device 212 via a display interface 210. In addition, the STB processor 204 can receive commands from a remote control device 218 via a remote interface 216.

In a particular embodiment, the memory device 206 can include a video content control and buffer module 220 that is executable by the STB processor 204 to receive video content via the IPTV access network 230 and to buffer the video content before transmitting it to the display interface 210, in order to prevent underflow. The video content control and buffer module 220 can be executable by the STB processor 204 to communicate with the application server 232, a video server, or any combination thereof, to receive video content of a channel that enables a user to place an order, make a payment, or any combination thereof, with respect to updating client software, operating systems, or any combination thereof, at the set-top box device 202. Further, the memory device 206 can include an application acquisition module 222 that is executable by the STB processor 204 to receive a request from a user to launch an application at the set-top box device 202. In addition, the application acquisition module 222 can be executable by the STB processor 204 to request the application from the application server 232 and to receive the application from the application server 232 when the set-top box device 202 can support execution of the application.

In an illustrative embodiment, the application acquisition module 222 can be executable by the STB processor 204 to receive header information related to a requested application, where the header information indicates one or more minimum or recommended system requirements to execute a requested application. The memory device 206 can include a STB capabilities module 224 that is executable by the STB processor 204 to store data related to processing capabilities of the set-top box device 202, such as processor speed, memory capacities, graphics capabilities, sound capabilities, operating system versions, client application versions, Internet connectivity, or any combination thereof. Further, the STB capabilities module 224 can be executable by the STB processor 204 to compare one or more processing capabilities of the set-top box device 202 with application header information received from the application server 232. In addition, the STB capabilities module 224 can be executable by the STB processor 204 to send data to the application server 232 indicating whether one or more capabilities of the set-top box device 202 meet or exceed one or more minimum or recommended system requirements of a requested application.

In a particular embodiment, the memory device 206 can include a graphic user interface (GUI) module 226 that is executable by the STB processor 204 to send a GUI to the display device 212 indicating that a requested application is incompatible or unavailable, when the set-top box device 202 cannot support execution of the application. The GUI module 226 can be executable by the STB processor 204 to generate the GUI, to receive the GUI from the application server 232, or any combination thereof. In an illustrative embodiment, the GUI module 226 can be executable by the STB processor 204 to include one or more selectable indicators of options to request an alternate version of an application, to update client software at the set-top box device 202, to update an operating system at the set-top box device 202, to replace hardware, or any combination thereof. In another illustrative embodiment, the GUI module 226 can be executable by the STB processor 204 to send a GUI to the display device 212 that enables a user to place an order, make payment, or any combination thereof, with respect to a client software update, operating system update, hardware replacement, or any combination thereof.

In a particular embodiment, the application server 232 can include an application server processor 234. The application server 232 can also include an application server memory device 236 that is accessible to the application server processor 234. The application server memory device 236 can include an application request module 238 that is executable by the application server processor 234 to communicate with the STB 202 to receive a request to launch an application. In an illustrative embodiment, an identifier of the set-top box device 202, such as a stock keeping unit (SKU) number or other identifier of the set-top box device 202 can be received with the request. Further, the application request module 238 can be executable by the application server processor 234 to determine whether the set-top box device 202 cannot support execution of a requested application. In an illustrative embodiment, if the set-top box device 202 cannot support execution of a requested application, the application request module 238 can be executable by the application server processor 234 to send to the set-top box device 202 data related to a message, GUI, or other indication that the application is not compatible with or available to the set-top box device 202.

In a particular embodiment, the application server memory device 236 can include a STB capability database 240 that is executable by the application server processor 234 to store system capabilities associated with a plurality of set-top box devices. The application request module 238 can be executable by the application server processor 234 to compare one or more minimum or recommended system requirements of an application requested at the set-top box device 202 with one or more system capabilities of the set-top box device 202 that are stored at the STB capability database 240. In an illustrative embodiment, the application request module 238 can be executable by the application server processor 234 to send the requested application to the set-top box device 202, when one or more system capabilities of the set-top box device 202 meet or exceed one or more minimum or recommended system requirements of the requested application.

In another particular embodiment, the application request module 238 can be executable by the application server processor 234 to send header information related to a requested application to the set-top box device 202. In an illustrative embodiment, the application request module 238 can be executable by the application server processor 234 to send the requested application to the set-top box device 202, when the application server 232 receives data from the set-top box device 202 indicating that it can support the requested application.

In a particular embodiment, the application server memory device 236 can include a STB validation module 242 that is executable by the application server processor 234 to validate the set-top box device 202 before sending a requested application to the set-top box device 202. In an illustrative embodiment, the user account records database 248 can store user account records that associate user information, location information, or any combination thereof, with identifiers of set-top boxes, such as stock keeping unit (SKU) identifiers, serial numbers, or other identifiers. The STB validation module 242 can be executable by the application server processor 234 to retrieve data associated with a set-top box identifier from the user account records database 248. The STB validation module 242 can be executable by the application server processor 234 to determine, for instance, whether the set-top box device 202 is at a location or IP address specified by data stored at the user account records database 248. In another embodiment, STB validation module 238 can be executable by the application server processor 234 to determine whether a user associated with the set-top box device 202 is permitted to access the requested application.

In a particular embodiment, the application server memory device 236 can include an application store 244 to store a plurality of applications that may be requested at the set-top box device 202, to store minimum system requirements of each such application, to store recommended system requirements of each such application, to store header information related to each such application, or any combination thereof.

In a particular embodiment, the application server memory device 236 can include an update module 246. The update module 246 can be executable by the application server processor 234 to receive requests for updates or replacements of operating systems, client software, hardware, or any combination thereof, from set-top box devices, such as the set-top box device 202. Further, the update module 246 can be executable by the application server processor 234 to send, or instruct another server of the IPTV system to send, a graphical user interface, video content, or any combination thereof, to enable a customer to order, remit payment for, and schedule delivery, pick-up, or installation of, operating system updates, client software updates, replacement hardware, or any combination thereof.

In an illustrative embodiment, the various modules 220-226 and 236-246 can include logic, hardware, computer instructions, or any combination thereof.

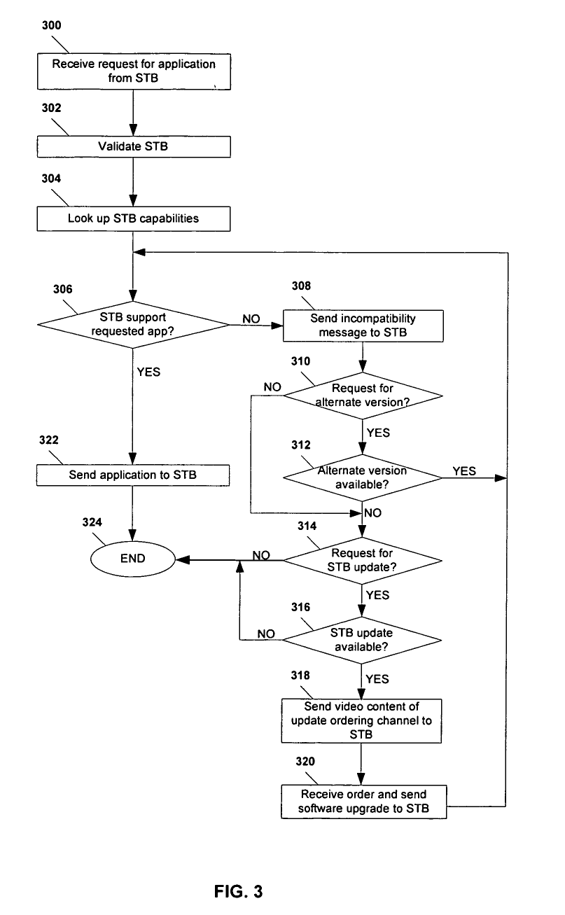

Referring to FIG. 3, a particular illustrative embodiment of a method of providing a set-top box application is illustrated. At block 300, an application server of an Internet Protocol Television Protocol (IPTV) system receives a request from a set-top box device for a particular set-top box application, such as an electronic program guide (EPG), an enhanced advertising feature, a gaming application, an Internet search feature, a retail purchasing application, a music application, a video-on-demand (VoD) application, such as a VoD storefront application, or any combination thereof.

Moving to block 302, in an illustrative, non-limiting embodiment, the application server can validate the set-top box device. For example, the application can access or query a user account records data store that associates user information, location information, or any combination thereof, with identifiers of set-top boxes, such as stock keeping unit (SKU) identifiers, serial numbers, or other identifiers. The application server can receive an identifier from the set-top box device with a request for an application and can retrieve data associated with the identifier from the user account records data store. The application server can determine, for instance, whether the set-top box device is at a location or IP address specified by data stored at the user account records data store. In another embodiment, the application server can determine whether a user associated with the set-top box device is permitted to access the requested application.

Proceeding to block 304, in an illustrative embodiment, the application server retrieves processing system capabilities of the set-top box device. In an illustrative embodiment, the application server can include a database that stores identifiers of set-top box devices in association with capabilities of those set-top box devices, such as processor speeds, versions of client applications, operating system versions, available read-only memory, available random access memory, graphics capabilities, sound capabilities, other processing capability indicators, or any combination thereof. In another embodiment, the application server can be coupled to such a database or to a computing device that includes the database. The application server can retrieve data related to one or more capabilities of the set-top box device that has requested an application, for example, based on an identifier received with the request.

Continuing to decision step 306, the application server determines whether the set-top box device can support execution of the requested application. In a particular embodiment, the application server can compare one or more capabilities of the set-top box device with one or more minimum system requirements of the application, one or more recommended system requirements of the application, or any combination thereof, in order to determine whether the set-top box device can support execution of the requested application. For instance, the application server can determine whether a speed of the set-top box processor meets or exceeds a minimum processor speed or a recommended processor speed to execute the requested application. In another example, the application server can determine whether the set-top box device stores a minimum or recommended version of a client application, an operating system, or any combination thereof.

If the application server determines that the set-top box device can support execution of the requested application, the method advances to block 322, and the application server sends the requested application to the set-top box device. The method then terminates at 324. Returning to decision step 306, in an illustrative embodiment, if the application server determines that the set-top box device cannot support execution of the requested application, the method moves to block 308 and the application server can send a message to the set-top box device indicating that the requested application is incompatible with or unavailable to the set-top box device. The method then proceeds to decision step 310.

At decision step 310, in a particular embodiment, the application server can determine whether it has received a request for an alternate version of the requested application, such as a second-tier application that requires less processing capability, such as a lower processor speed or an earlier version of client software or an operating system. If the application server determines that it has not received such a request, the method can proceed to decision step 314. On the other hand, if the application server determines that it has received a request for an alternate version of the requested application, the method continues to decision step 312, and the application server determines whether an alternate version of the requested application is available. For example, the application server can determine whether an alternate version is stored at the application server or can be retrieved by the application server via the Internet or a private network. If the application server determines that an alternate version of the requested application is available, the method returns to decision step 306 and continues. Whereas, if the application server determines that an alternate version of the requested application is not available, the method moves to decision step 314.

Proceeding to decision step 314, in a particular embodiment, the application server can determine whether it has received a request to update the requested set-top box device by providing, for example, an updated version of an operating system, client software, or any combination thereof. If the application server does not receive a request for a set-top box update, the method terminates at 324. Conversely, if the application server receives a request for a set-top box update, the application server can determine whether newer or updated versions of the set-top box device's operating system, client software, or any combination thereof, are stored at the application server or is available via the Internet or a private network. If no set-top box update is available, the method terminates at 324.

Returning to decision step 316, in an illustrative, non-limiting embodiment, if one or more newer or updated versions of the operating system, client software, or any combination thereof, are available, the method can move to block 318, and the application server can send, or instruct a video server or other server of the IPTV system to send, video content of an update ordering channel to the set-top box device. Continuing to block 320, the application server can receive an order, payment, or any combination thereof, for the set-top box update and can send updated versions of the operating system, client software, or any combination thereof, to the set-top box device. In a particular embodiment, the method can return to decision step 306 and continues as described. For example, and the application server can determine whether the set-top box device can support execution of the requested application as a result of the update. The method terminates at 324.

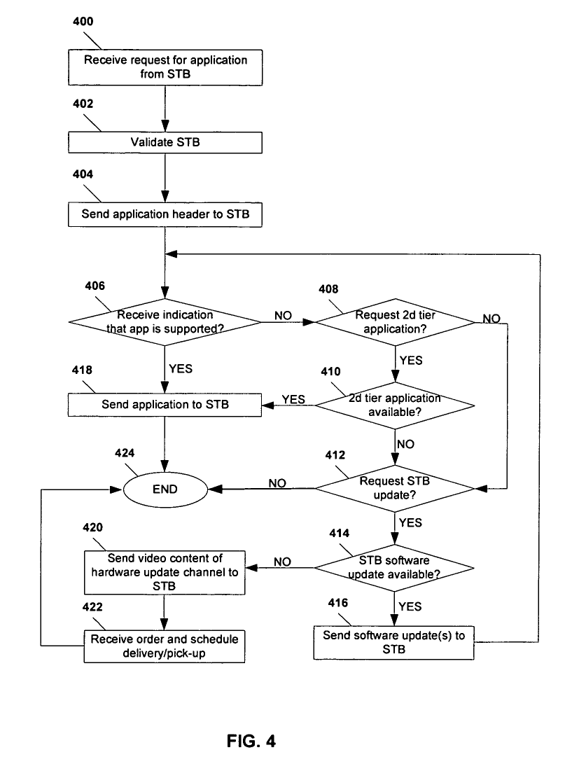

Referring to FIG. 4, a second particular illustrative embodiment of a method of providing a set-top box application is illustrated. At block 400, an application server of an Internet Protocol Television Protocol (IPTV) system receives a request from a set-top box device for a particular set-top box application, such as an electronic program guide (EPG), an enhanced advertising feature, a gaming application, an Internet search feature, a retail purchasing application, a music application, a video-on-demand (VOD) application, such as a VOD storefront application, or any combination thereof.

Moving to block 402, in an illustrative, non-limiting embodiment, the application server can validate the set-top box device. For example, the application can access or query a user account records data store that associates user information, location information, or any combination thereof, with identifiers of set-top boxes, such as stock keeping unit (SKU) identifiers, serial numbers, or other identifiers. The application server can receive an identifier from the set-top box device with a request for an application and can retrieve data associated with the identifier from the user account records data store. The application server can determine, for instance, whether the set-top box device is at a location or IP address specified by data stored at the user account records data store. In another embodiment, the application server can determine whether a user associated with the set-top box device is permitted to access the requested application.

Proceeding to block 404, in an illustrative embodiment, the application server can send header information associated with the application to the set-top box device. In an illustrative embodiment, the header information can include one or more minimum system requirements, one or more recommended system requirements, or any combination thereof, to execute the application. Continuing to decision step 406, the application server can determine whether it has received data from the set-top box device indicating that the set-top box device can support the requested application. For example, the set-top box device can compare the one or more minimum system requirements, one or more recommended system requirements, or any combination thereof, included in the header information with system capabilities stored at the set-top box device, in order to determine whether the set-top box device can support execution of the requested application. The set-top box device can send data to the application server indicating whether set-top box device can support execution of the requested application.

In a particular embodiment, if the application server determines that it has received data from the set-top box device indicating that the set-top box device can support the requested application, the method advances to block 418, and the application server sends the requested application to the set-top box device. The method then terminates at 424. Returning to decision step 406, in an illustrative embodiment, if the application server determines that it has received data from the set-top box device indicating that the set-top box device cannot support the requested application, the method moves to block 408 and the application server can determine whether it has received a request for an alternate version of the requested application, such as a second-tier application that requires less processing capability, such as a lower processor speed or an earlier version of client software or an operating system. If the application server determines that it has not received such a request, the method can proceed to decision step 412.

On the other hand, if the application server determines that it has received a request for an alternate version of the requested application, the method continues to decision step 410, and the application server determines whether an alternate version of the requested application is available. For example, the application server can determine whether an alternate version is stored at the application server or can be retrieved by the application server via the Internet or a private network. If the application server determines that an alternate version of the requested application is available, the application server can send the alternate version of the application to the set-top box device. Whereas, if the application server determines that an alternate version of the requested application is not available, the method moves to decision step 412.

Proceeding to decision step 412, in a particular embodiment, the application server can determine whether it has received a request to update the requested set-top box device by providing, for example, an updated version of an operating system, client software, replacement hardware, or any combination thereof. If the application server does not receive a request for a set-top box update, the method terminates at 424. Conversely, if the application server receives a request for a set-top box update, the application server can determine whether replacement hardware is available in a customer's area, or whether newer or updated versions of the set-top box device's operating system, client software, or any combination thereof, are stored at the application server or is available via the Internet or a private network.

In an illustrative, non-limiting embodiment, if no set-top box update is available, the method can proceed to block 420, and the application server can send, or cause a video server to send, video content of a set-top box device hardware-ordering channel to the set-top box device. For example, the hardware-ordering channel can provide static or interactive content informing a customer of available devices and costs associated therewith. In a particular embodiment, a customer can order and submit payment for replacement hardware by issuing commands to the current set-top box device according to instructions given by the video content shown via the ordering channel. Moving to block 422, the application server or other server of the IPTV system can receive an order for a replacement set-top box device and schedule a delivery or pick-up time and location. The method can then terminate at 424.

Returning to decision step 414, in an illustrative, non-limiting embodiment, if one or more newer or updated versions of the operating system, client software, or any combination thereof, are available, the method can move to block 416, and the application server can send updated versions of the operating system, client software, or any combination thereof, to the set-top box device. In a particular embodiment, the method can return to decision step 406 and continues as described. For example, and the application server can determine whether the set-top box device can support execution of the requested application as a result of the software update. The method terminates at 424.

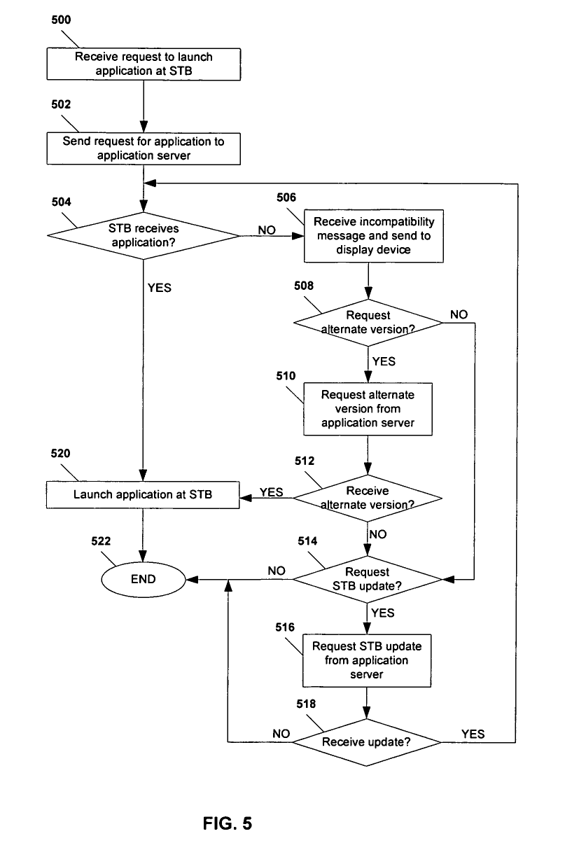

Referring to FIG. 5, a particular illustrative embodiment of a method of receiving a set-top box application is illustrated. At block 500, a set-top box device receives a request from a user to launch a particular set-top box application, such as an electronic program guide (EPG), an enhanced advertising feature, a gaming application, an Internet search feature, a retail purchasing application, a music application, a video-on-demand (VOD) application, such as a VOD storefront application, or any combination thereof. Moving to block 502, the set-top box device sends a request for the set-top box application to an application server of an Internet Protocol Television (IPTV) system.

Proceeding to block 504, in a particular embodiment, the set-top box device can determine whether it has received the application. If the set-top box device receives the application, the method advances to block 520, and the set-top box device launches the application. The method then terminates at 522. Returning to decision step 506, in an illustrative, non-limiting embodiment, if the set-top box device does not receive the application, the method moves to block 508 and the set-top box device can receive a message from the application server indicating that the requested application is incompatible with or unavailable to the set-top box device. The set-top box device can send the message to a display device coupled to the set-top box device. The method then proceeds to decision step 508.

At decision step 508, in a particular embodiment, the set-top box device can determine whether it has received a command to request an alternate version of the requested application, such as a second-tier application that requires less processing capability, such as a lower processor speed or an earlier version of client software or an operating system. For example, a graphical user interface (GUI) can be displayed at the display device that presents a user with a selectable option to determine whether an alternate version of the application is available. An example of such a GUI is illustrated in FIG. 7.

If the set-top box device determines that it has not received a command to request an alternate version of the application, the method can proceed to decision step 514. On the other hand, if the set-top box device determines that it has received a command to request an alternate version of the application, the method continues to block 510, and the set-top box device sends a request for an alternate version of the application to the application server. In a particular embodiment, the method advances to decision step 512, and the set-top box device can determine whether it has received an alternate version of the application. If the set-top box device determines that an alternate version of the requested application has been received, the method moves to block 520, and the set-top box application launches the alternate version of the application. Whereas, if the set-top box device does not receive the alternate version of the application, the method moves to decision step 514.

Proceeding to decision step 514, in a particular embodiment, the set-top box device can determine whether it has received a command to request a set-top box update, such as an updated version of an operating system, client software, or any combination thereof. If the set-top box device does not receive a command to request a set-top box update, the method terminates at 522. Conversely, if the set-top box device determines that it has received a command to request a set-top box update, the method can move to block 516, and the set-top box device can send a request for a set-top box update to the application server. Continuing to decision step 518, the set-top box device can determine whether it has received the set-top box update. In a particular embodiment, if the set-top box device receives the set-top box update, the method can return to decision step 504 and continue as described. For example, the application server can determine that the set-top box device can support execution of the requested application as a result of the update, and the set-top box device can receive the requested application. Returning to decision step 518, if the set-top box device does not receive the set-top box update, the method terminates at 524.

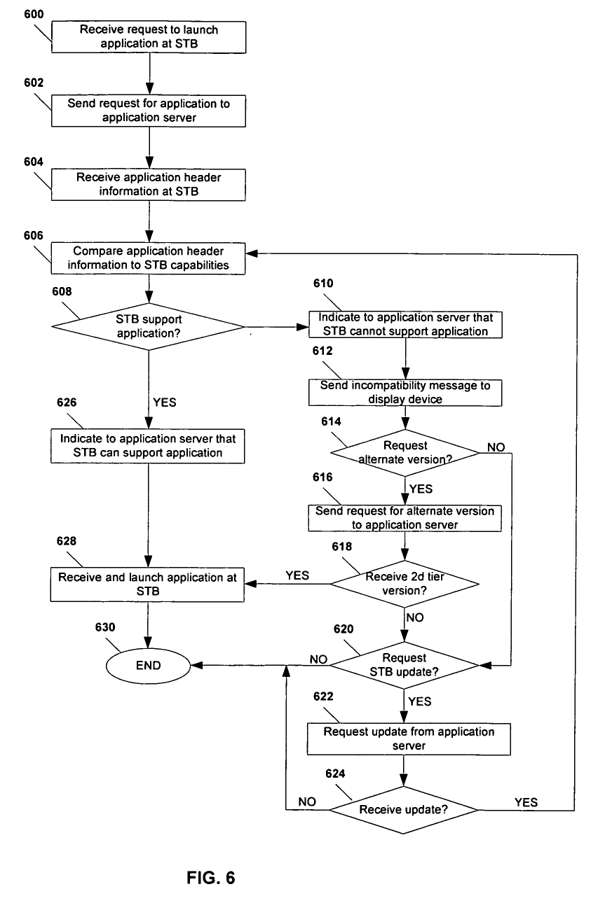

Referring to FIG. 6, a second particular illustrative embodiment of a method of receiving a set-top box application is illustrated. At decision step 600, a set-top box device receives a request from a user to launch a particular set-top box application, such as an electronic program guide (EPG), an enhanced advertising feature, a gaming application, an Internet search feature, a retail purchasing application, a music application, a video-on-demand (VOD) application, such as a VOD storefront application, or any combination thereof. Moving to block 602, the set-top box device sends a request for the set-top box application to an application server of an Internet Protocol Television (IPTV) system.

Proceeding to block 604, in a particular embodiment, the set-top box device can receive header information related to the application. In an illustrative embodiment, the header information can include one or more minimum system requirements, one or more recommended system requirements, or any combination thereof, to execute the requested application. Continuing to block 608, the set-top box device can compare the application header information with processing system capabilities of the set-top box device. For example, the set-top box device can access data stored at the set-top box device that is related to system capabilities of the set-top box device, such as a processor speed, a client software version, an operating system version, available read-only memory, available random access memory, graphics capabilities, sound capabilities, other processing capability indicators, or any combination thereof, and determine whether such system capabilities meet or exceed system requirements include in the application header information.

At decision step 608, the set-top box device can determine whether it can support execution of the requested application, based on the application header information. In an illustrative embodiment, if the set-top box device determines that is can support execution of the requested application, the method advances to block 626, and the set-top box device sends data to the application server indicating that the set-top box device support execution of the requested application. Continuing to block 628, the set-top box device receives and launches the requested application. The method terminates at 630.

Returning to decision step 608, in a particular embodiment, if the set-top box device determines that it cannot support the requested application, the method moves to block 610, and the set-top box device can send data to the application server indicating that the set-top box device cannot support the application. In an illustrative embodiment, the method proceeds to block 612, and the set-top box device can generate and send a message to a display device coupled to the set-top box device indicating that the requested application is incompatible with or unavailable to the set-top box device. In an exemplary, the set-top box device can send a graphical user interface (GUI) that includes the message and one or more selectable indicators of options to the display device. An example of such a GUI is illustrated in FIG. 7.

In a particular embodiment, the method moves to decision step 614, and the set-top box device determines whether it has received a command to request an alternate version of the requested application, such as a second-tier application that requires less processing capability, such as a lower processor speed or an earlier version of client software or an operating system. For example, a graphical user interface (GUI) can be displayed at the display device that presents a user with a selectable option to determine whether an alternate version of the application is available. An example of such a GUI is illustrated in FIG. 7.

If the set-top box device determines that it has not received a command to request an alternate version of the application, the method can proceed to decision step 620. On the other hand, if the set-top box device determines that it has received a command to request an alternate version of the application, the method continues to block 616, and the set-top box device sends a request for an alternate version of the application to the application server. In a particular embodiment, the method advances to decision step 618, and the set-top box device can determine whether it has received an alternate version of the application. If the set-top box device determines that an alternate version of the requested application has been received, the method moves to block 628, and the set-top box application launches the alternate version of the application. Whereas, if the set-top box device does not receive the alternate version of the application, the method moves to decision step 620.

Proceeding to decision step 620, in a particular embodiment, the set-top box device can determine whether it has received a command to request a set-top box update, such as an updated version of an operating system, client software, or any combination thereof. If the set-top box device does not receive a command to request a set-top box update, the method terminates at 630. Conversely, if the set-top box device determines that it has received a command to request a set-top box update, the method can move to block 622, and the set-top box device can send a request for a set-top box update to the application server. Continuing to decision step 624, the set-top box device can determine whether it has received the set-top box update. In a particular embodiment, if the set-top box device receives the set-top box update, the method can return to decision step 606 and continue as described. For example, the application server can determine that the set-top box device can support execution of the requested application as a result of the update, and the set-top box device can receive the requested application. Returning to decision step 624, if the set-top box device does not receive the set-top box update, the method terminates at 630.

In a particular embodiment, the steps of the methods described herein can be executed in the order shown by the figures. In alternative embodiments, some steps can be executed simultaneously or in alternative sequences.

Referring to FIG. 7, a graphical user interface (GUI) to provide a set-top box application is illustrated and designated generally 700. The GUI 700 can include a message 702 indicating that a requested application is not compatible with a set-top box device requesting the application. Further, the GUI 760 can include a plurality of selectable indicators 704 related to options that a user can choose in response to the message 702. For example, the GUI 700 can include a selectable indicator of an option to request another version of the application. In addition, the GUI 700 can include a selectable indicator of an option to request a software upgrade for the set-top box device, such as a client software upgrade, operating system upgrade, or any combination thereof. The GUI 700 can also include a selectable indicator of an option to exit the GUI 700. In an illustrative, non-limiting embodiment, the selectable indicators 704 can be selected by manipulating a highlight bar using cursor or arrow keys on a remote control device communicating with the set-top box device and pressing an ‘OK,’ ‘ENTER,’ or similar button on the remote control device.

In conjunction with the configuration of structure described herein, the system and method disclosed provide a set-top box application to a requesting set-top box device. In a particular illustrative embodiment, a set-top box device can receive a request from a user to launch a particular application. For example, the user can attempt to launch an electronic program guide (EPG), an enhanced advertising feature, a gaming application, an Internet search feature, a retail purchasing application, a music application, a video-on-demand (VoD) application, such as a VoD storefront application, or any combination thereof. The set-top box device can send a request for the application to an application server of an IPTV system.

In a particular embodiment, the application server can determine whether a processing system of the set-top box device can support the requested application. For instance, the application server can determine whether a speed of the set-top box processor meets or exceeds a minimum processor speed or a recommended processor speed to execute the requested application. In another example, the application server can determine whether the set-top box device stores a minimum or recommended version of a client application, an operating system, or any combination thereof.

In an illustrative embodiment, the application server can include a database that stores identifiers of set-top box devices in association with capabilities of those set-top box devices, such as processor speeds, versions of client applications, operating system versions, available read-only memory, available random access memory, graphics capabilities, sound capabilities, other processing capability indicators, or any combination thereof. In another embodiment, the application server can be coupled to such a database or to a computing device that includes the database. The application server can retrieve data related to one or more capabilities of the set-top box device that has requested an application, for example, based on an identifier received with the request. The application server can compare the one or more capabilities of the set-top box device with one or more minimum system requirements of the application, one or more recommended system requirements of the application, or any combination thereof, in order to determine whether the set-top box device can support execution of the requested application.

In another particular embodiment, the application server can determine whether the set-top box device can support execution of the requested application by sending header information associated with the application to the set-top box device. The header information can include one or more minimum system requirements, one or more recommended system requirements, or any combination thereof, to execute the application. The set-top box device can compare the one or more minimum system requirements, one or more recommended system requirements, or any combination thereof, with system capabilities stored at the set-top box device, in order to determine whether the set-top box device can support execution of the requested application. The set-top box device can send data to the application server indicating whether set-top box device can support execution of the requested application.

If the application server determines that the set-top box device can support execution of the requested application, the application server can send the requested application to the set-top box device. The set-top box device can launch the application and send related content, graphics, user interfaces, or any combination thereof, to the television monitor coupled to the set-top box device.

In an illustrative embodiment, if the application server determines that the set-top box device cannot support execution of the requested application, the application server can send to the set-top box device data related to a message indicating that the application is not supported by or not available to the set-top box device. In another illustrative embodiment, the set-top box device can generate such a message, for example, where the set-top box device determines whether it can support execution of the requested application based on header information received from the application server.

In a particular embodiment, the application server can determine whether an alternate version of a requested application is available when it determines that the set-top box device cannot support execution of the requested application. For example, the application server can determine whether a version that requires a lower processor speed or an early client software version, is stored at the application server or can be retrieved by the application server via the Internet or a private network. In an illustrative embodiment, the application server can make such a determination automatically after it determines that the set-top box device cannot support the requested application. Alternatively, a request can be received from the set-top box device to determine whether an alternate version of the application is available. For example, a graphical user interface (GUI) can be displayed at the television monitor that presents a user with a selectable option to determine whether an alternate version of the application is available. If the application server determines that an alternate version of the application is available, it can determine whether the set-top box device can support the alternate version of the application. If the set-top box device can support the alternate version, the application server can send the alternate version of the application to the set-top box device.

In another particular embodiment, the application server can determine whether an updated version of an operating system, client software, or any combination thereof, is available when it determines that the set-top box device cannot support execution of the requested application. For example, the application server can determine that execution of a requested application cannot be supported by the set-top box device, because the application requires a newer version of the operating system, client software, or any combination thereof, stored at the set-top box device. The application server can determine whether newer or updated versions of the operating system, client software, or any combination thereof, is stored at the application server or is available via the Internet or a private network. If one or more newer or updated versions of the operating system, client software, or any combination thereof, are available, the application server can send a newer or updated version of the operating system, client software, or any combination thereof, to the set-top box device. Further, if the set-top box device can support execution of the requested application as a result of an update to its the operating system, client software, or any combination thereof, the application server can send the requested application to the set-top box device.

In an illustrative embodiment, an graphical user interface (GUI), such as a purchase or order screen, can be displayed at the television monitor that presents a user with an option to purchase updates for the operating system, client software, or any combination thereof, stored at the set-top box device. The GUI can be generated by the application server, by the set-top box device, or any combination thereof. In another illustrative embodiment, the application server can instruct a video server or other server of the IPTV system to send video content of a channel that enables a user to place an order, make a payment, or any combination thereof, with respect to updating client software, an operating system, or any combination thereof, at the set-top box device. The application server can send a newer or updated version of the operating system, client software, or any combination thereof, to the set-top box device after an order, payment, or any combination thereof, for the newer or updated versions is confirmed by the application server or other server of the IPTV system.

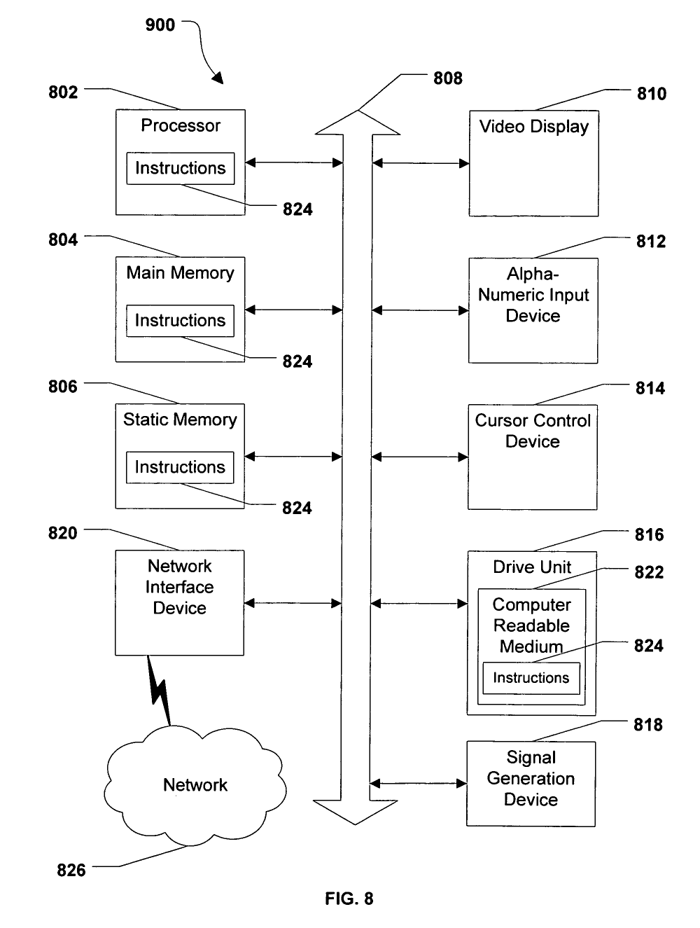

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800, or any portion thereof, may operate as a standalone device or may be connected, e.g., using a network, to other computer systems or peripheral devices, including a server or set-top box device, as shown in FIGS. 1-2.

In a networked deployment, the computer system may operate in the capacity of an IPTV server, such as a video server or application server, or a set-top box device. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics-processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. Further, the computer system 800 can include a wireless input device 815, e.g., a remote control device. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing a set-top box application, the method comprising:
receiving a request from a set-top box device to launch a set-top box application;
determining whether a processing system of the set-top box device supports execution of the set-top box application; and
sending the set-top box application to the set-top box device after determining that the processing system of the set-top box device can support execution of the set-top box application.

2. The method of claim 1, further comprising determining whether at least one system capability of the set-top box device meets or exceeds at least one system requirement of the set-top box application, wherein the set-top box application is sent to the set-top box device after determining that the at least one system capability meets or exceeds the at least one system requirement.

3. The method of claim 2, wherein the at least one system capability includes a processor speed and the at least one system requirement includes a minimum processor speed, a recommended processor speed, or any combination thereof.

4. The method of claim 2, wherein the system capability is a client software version, an operating system version, or any combination thereof, stored at the set-top box device and wherein the system requirement is a minimum client software version, a recommended client software version, a minimum operating system version, a recommended operating system version, or any combination thereof.

5. The method of claim 4, further comprising sending an updated version of the client software, an updated version of the operating system, or any combination thereof, to the set-top box device when the system capability does not meet or exceed the system requirement.

6. The method of claim 5, wherein video content of an update ordering channel is sent to the set-top box device and the updated version is purchased by a user of the set-top box device.

7. The method of claim 2, further comprising retrieving data related to the at least one system capability from a data store that associates data related to system capabilities of each of a plurality of set-top box devices with identifiers of each of the plurality of set-top box devices.

8. The method of claim 1, further comprising:
identifying an alternate version of the set-top box application after determining that the set-top box device does not support execution of the set-top box application;
determining that the processing system of the set-top box device supports execution of the alternate version of the set-top box application; and
sending the alternate version of the set-top box application to the set-top box device.

9. A method of receiving a set-top box application, the method comprising:
sending a request for an application to an application server, wherein the application server determines whether a processing system of the set-top box device supports execution of the application; and
receiving the application when the processing system of set-top box device supports execution of the application.

10. The method of claim 9, wherein the application is a music application, a gaming application, an electronic program guide application, a video-on-demand application, an enhanced advertising application, a retail purchasing application, or any combination thereof.

11. The method of claim 9, further comprising:
receiving a header portion of the application from the application server at the set-top box device;
determining whether the processing system of the set-top box device supports execution of the application; and
sending data to the application server indicating whether the processing system of the set-top box device supports execution of the application.

12. The method of claim 11, further comprising generating a message stating that the application is incompatible with the set-top box device and sending the message to a display device coupled to the set-top box device when the processing system of the set-top box device does not support execution of the application.

13. The method of claim 9, further comprising receiving a message from the application server indicating that the application is incompatible with the set-top box device and sending the message to a display device coupled to the set-top box device when the processing system of the set-top box device does not support execution of the application.

14. A system to provide a set-top box application, the system comprising:
an application server having a processor and a memory device accessible to the processor;
wherein the memory device includes instructions to communicate with a set-top box device to receive a request to launch a set-top box application; and
wherein the memory device includes instructions to determine whether a processing system of the set-top box device supports execution of the application.

15. The system of claim 14, wherein the memory device includes instructions to send the application to the set-top box device after it is determined that the processing system of the set-top box device supports execution of the application.

16. The system of claim 14, wherein the memory device includes:
instructions to retrieve data related to a plurality of system capabilities of the set-top box device from a data store that associates data related to system capabilities of a plurality of set-top box devices with identifiers of the plurality of set-top box devices;
instructions to compare the data related to the plurality of system capabilities of the set-top box device with a plurality of system requirements of the application; and
wherein it is determined that the processing system of the set-top box device supports execution of the application when each of the plurality of system capabilities meets or exceeds a corresponding one of the system requirements.

17. The system of claim 14, wherein the memory device includes instructions to determine an identifier of the set-top box device and to validate that the set-top box device is at a customer premise associated with the identifier of the set-top box device in a user account record, before sending the application to the set-top box device.

18. The system of claim 14, wherein the memory device includes:
instructions to determine that an alternate version of the application can be retrieved via the Internet after it is determined that the processing system of the set-top box device cannot support execution of the application; and
instructions to retrieve the alternate version of the application via the Internet and to send the alternate version of the application to the set-top box device.

19. A set-top box device, comprising:
a processor and a memory device accessible to the processor;
wherein the memory device includes instructions to send a request for an application to an application server that includes logic to determine whether a processing system of the set-top box device supports execution of the application; and
wherein the memory device includes instructions to communicate with the application server to receive the application when the processing system of set-top box device supports execution of the application.

20. The set-top box device of claim 19, wherein the memory device includes instructions to display a graphical user interface (GUI) when the processing system of the set-top box device does not support execution of the application, the GUI including a message indicating that the application is incompatible with the set-top box device.

21. The set-top box device of claim 20, wherein the GUI includes a selectable indicator of an option to request an alternate version of the application, a selectable indicator of an option to update client software stored at the set-top box device, a selectable indicator of an option to update an operating system stored at the set-top box device, or any combination thereof.

22. The set-top box device of claim 21, wherein the memory device includes:
instructions to request an alternate version of the application from the application server after receiving a selection via the GUI of the indicator of the option to request an alternate version of the application; and
instructions to communicate with the application server to receive the alternate version of the application when the set-top box device supports the alternate version of the application.

23. The set-top box device of claim 21, wherein the memory device includes:
instructions to request an updated version of the client software from the application server after receiving a selection via the GUI of the indicator of the option to update the client application; and
instructions to communicate with the application server to receive the updated version of the client application.

24. The set-top box device of claim 21, wherein the memory device includes:
instructions to request an updated version of the operating system from the application server after receiving a selection via the GUI of the indicator of the option to update the operating system; and
instructions to communicate with the application server to receive the updated version of the operating system.

25. The set-top box device of claim 19, wherein the memory device includes instructions to send an identifier of the set-top box device with the request for the application.
